(19) United States
(12) Patent Application Publication
(10) Pub. No.: US 2013/0029133 A1
(43) Pub. Date: Jan. 31, 2013

(54) LAMINATES AND PROCESS FOR PRODUCING LAMINATES

(71) Applicant: Kiyoshi ITOH, Kanagawa (JP)

(72) Inventor: Kiyoshi ITOH, Kanagawa (JP)

(21) Appl. No.: 13/192,741

(22) Filed: Jul. 28, 2011

(51) Int. Cl. B32B 5/00; B29C 47/06; B29C 70/00

(52) U.S. Cl. 428/332; 264/171.13

(57) ABSTRACT

Provided are (1) a method of producing a laminate that is based on an application mode in which the laminate is formed by one application process, by preparing a plurality of solutions by dissolving components for forming layers in solvents, laminating the plurality of solutions thus obtained, transferring the solutions onto a substrate, and drying the solutions, and (2) a laminate that can be produced by the production method. Specifically, provided are (a) a laminate having at least one pair of layers adjacent to each other, the laminate showing a detected peak having a full width at half maximum of 0.01 to 0.7 μm at a depth where an interfacial region between the layers adjacent to each other exists in elemental quantitative analysis in its depth direction by a glow discharge optical emission spectrometry, and (b) a method of producing the laminate.

### FIELD OF THE INVENTION

The present invention relates to a laminate having high interlayer adhesiveness and a method of producing the laminate, and more specifically, to a laminate having at least one pair of layers adjacent to each other, the laminate showing a detected peak having a full width at half maximum of 0.01 to 0.7 μm at a depth where an interfacial region between the layers adjacent to each other exists in elemental quantitative analysis in its depth direction by a glow discharge optical emission spectrometry, and a method of producing the laminate.

### BACKGROUND OF THE INVENTION

A method involving using an organic solvent-based solution prepared by dissolving a component for forming a layer in an organic solvent and a method involving using an aqueous solution prepared by dissolving the component for forming a layer in an aqueous solvent (which may hereinafter be referred to as “aqueous solution for forming a layer”) have been known as methods for the formation of a laminate.

A tandem application mode in which the application of the solution in which the component for forming a layer is dissolved and a drying treatment are repeated has been known as a mode on which any such method of forming a laminate involving using a solution is based. In the tandem application mode, a solution for a lower layer must be fixed before a solution for an upper layer is applied lest the solution for a lower layer should be flowed by the solution for an upper layer. In particular, the tandem application mode in which the application and the drying treatment are repeated is not suitable for the production of a laminate involving using the aqueous solution for forming a layer because of the following reason. One drying step requires a very long time period and very large energy, and hence an extremely long time period and extremely large energy are needed in the tandem application mode. In addition, in the first place, the tandem application mode inevitably causes air to enter a gap between layers owing to the repetition of the application and the drying treatment. Accordingly, interlayer adhesiveness tends to be insufficient. Further, as the number of layers increases, the probability that foreign matter is included increases, which leads to a reduction in yield.

On the other hand, as a solution to the above-mentioned problems, there is known an application mode in which the laminate is formed by one application process (a process with which multiple layers are laminated at one time without interposing a drying treatment), and the multilayer application mode has been widely utilized in an application process for a photographic film or the like. As illustrated in FIG. 1 for example, the multilayer application mode involves: ejecting an upper layer solution A and a lower layer solution B from a plurality of narrow slits in an application head 1; causing the solutions to flow down naturally on an inclined slide surface 2 by gravitation; and transferring the overlapping upper layer solution A and lower layer solution B onto a running substrate 4 by a roll 3 to form a laminate.

As a method in which such multilayer application mode is adopted, the following method has been known: multiple layers of halogenated emulsions (sol solutions) each using gelatin as a binder are simultaneously applied while gelling the emulsions (see Patent Literature 1 and FIG. 6). The method intends to form a laminate by, for example, drying with hot air on the following condition: a multilayer film is caused to gel by utilizing the sol-gel transformation characteristic of gelatin so as to be in an ultrahigh-viscosity state, and hence, the occurrence of the mixing of layers is suppressed.

### CITATION LIST

### Patent Literature

[PTL 1] JP 58-199074 A

### SUMMARY OF THE INVENTION

### Problems to be solved by the Invention

The method described in Patent Literature 1 involves using a large amount of a gelling agent typified by gelatin for maintaining a laminated structure. As a result, the following problems arise. Various functions such as hard coat property and transparency cannot be imparted. Further, the applications of the resultant laminate are limited because of, for example, the following reason. A component that is incompatible or reacts with the gelling agent cannot be used.

It should be noted that in many cases, the gelling agent and a thickener that have been typically used for realizing lamination must be added in large amounts so that their effects may be obtained. Accordingly, such a concern as described below has been raised. The gelling agent or the thickener moves in a layer, or across layers, after the lamination to precipitate in a large amount in an interfacial region or on a surface, which may reduce a mechanical strength or interlayer adhesiveness. In addition, various kinds of materials have been proposed as the gelling agent and the thickener. As described in the foregoing, however, most of the materials must be added in large amounts. At present, the number of effective materials that have been proposed is not very large.

The present invention has been made under such circumstances, and an object of the present invention is to provide a method of producing a laminate that is based not on a tandem mode but on an application mode in which the laminate is formed by one application process, that obviates the need for the addition of a large amount of a gelling agent such as gelatin, and that can impart various functions such as hard coat property and transparency, the method enabling simple, high-productivity production of a laminate having high interlayer adhesiveness, and a laminate having high interlayer adhesiveness that can be produced by the production method.

### Means for Solving the Problems

The inventors of the present invention have made extensive studies to solve the problems, and as a result, have found that in an application mode in which a laminate is formed by one application process, a laminated structure of two solutions adjacent to each other is favorably maintained by the following. A component that causes a chemical reaction upon contact of the two solutions adjacent to each other is incorporated into at least one of the two solutions so that the chemical reaction of the component may be caused upon lamination of the two solutions. Then, a product produced by the chemical reaction is caused to exist in an insolubilized state in an interfacial region between two layers formed of the two solutions adjacent to each other.

The above-mentioned product existing in an insolubilized state exists as a dissimilar component in the interfacial region between the respective layers of the laminate thus formed. Accordingly, the laminate shows a detected peak having a full width at half maximum of 0.01 to 0.7 μm at a depth where the interfacial region between the layers adjacent to each other exists in elemental quantitative analysis in its depth direction by a glow discharge optical emission spectrometry. It can be assumed that in such laminate, the mixing of the layers is suppressed and a function which each layer should express can be expressed comparably. Meanwhile, it can also be assumed that high interlayer adhesiveness can be secured as a result of slight mixing of the layers. The present invention has been completed on the basis of such findings.

That is, the present invention relates to the following items [1] to [4]:

[1] a laminate including at least one pair of layers adjacent to each other, in which the laminate shows a detected peak having a full width at half maximum of 0.01 to 0.7 μm at a depth where an interfacial region between the layers adjacent to each other exists in elemental quantitative analysis in its depth direction by a glow discharge optical emission spectrometry;

[2] a laminate including at least one pair of layers adjacent to each other, in which the laminate shows a detected peak having a full width at half maximum of 0.01 to 0.7 μm at a depth where detected signals derived from the components that construct the upper and lower layers adjacent to each other contact each other in elemental quantitative analysis in its depth direction by a glow discharge optical emission spectrometry;

[3] a method of producing a laminate, including the steps of:

(1) laminating a plurality of solutions prepared by dissolving components for forming layers in solvents;

(2) transferring the solutions laminated in the step (1) onto a substrate; and

(3) drying the laminated solutions transferred onto the substrate,

in which:

solvents which two solutions adjacent to each other in the step (1) contain include the same solvent or solvents having compatibility with each other;

a component that causes a chemical reaction upon contact of the two solutions is incorporated into at least one of the two solutions so that the chemical reaction of the component is caused upon lamination of the two solutions in the step (1); and

a product produced by the chemical reaction is caused to exist in an insolubilized state in an interfacial region between two layers formed of the two solutions adjacent to each other; and

[4] the method of producing a laminate according to the above-mentioned item [3], in which the chemical reaction includes a crosslinking reaction, an agglomeration reaction based on salting out, a complex-forming reaction, a neutralization reaction between an acid and a base, or a polymerization reaction.

### Effect of the Invention

The laminate of the present invention suppresses the mixing of the layers, enables each layer to comparably express a function which the layer should express, and at the same time, has high interlayer adhesiveness as a result of slight mixing of the layers.

In addition, the production method of the present invention is a method of producing a laminate involving using a plurality of solutions prepared by dissolving components for forming layers in solvents in an application mode in which the laminate is formed by one application process, and despite the fact that the solvents which two solutions adjacent to each other contain are the same or have compatibility with each other, the method can suppress the mixing of the two solutions to be laminated. As a result, a laminate excellent in interlayer adhesiveness can be produced simply and with good productivity. The production method of the present invention is also a method capable of imparting various functions such as hard coat property and transparency to the laminate. Further, according to the production method of the present invention, a production cost can be reduced.

### BRIEF DESCRIPTION OF THE DRAWINGS

FIG. 1 is a schematic view illustrating an example of an apparatus for forming a laminate by one application process.

FIG. 2 is an image view illustrating the manner of a chemical reaction occurring in a step (1) of the present invention.

FIG. 3 is a spectrum view showing the result of the elemental quantitative analysis of a laminate obtained in Example 1 in its depth direction by a glow discharge optical emission spectrometry.

FIG. 4 is a schematic sectional view of a laminate of the present invention.

FIG. 5 is a scanning electron microscope (SEM) photograph of a section of the laminate obtained in Example 1.

FIG. 6 is a flow chart illustrating the outlines of a method of producing a laminate described in Patent Literature 1 and a method of producing a laminate of the present invention.

### DESCRIPTION OF EMBODIMENTS

### Laminate

The laminate of the present invention is a laminate having at least one pair of layers adjacent to each other, the laminate showing a detected peak having a full width at half maximum of 0.01 to 0.7 μm at a depth where an interfacial region between the layers adjacent to each other exists in elemental quantitative analysis in its depth direction by a glow discharge optical emission spectrometry. The term “interfacial region” as used herein refers to a region where the layers adjacent to each other mix with each other or to the very interface between the layers adjacent to each other when substantially no region where the layers mix with each other exists.

The full width at half maximum of the detected peak is preferably 0.01 to 0.7 μm, more preferably 0.05 to 0.6 μm, still more preferably 0.1 to 0.6 μm from the viewpoint of the establishment of a balance between a suppressing effect on the mixing of the upper and lower layers between which the interfacial region is interposed, and an improving effect of some degree of mixing of the layers on adhesiveness.

The peak top of the detected peak in the elemental quantitative analysis in the depth direction by the glow discharge optical emission spectrometry is typically present at the depth where the interfacial region exists.

It should be noted that the full width at half maximum represents the depth range in which a component from which the detected peak is derived (dissimilar component to be described later) spreads. As the full width at half maximum reduces, a state in which the upper and lower layers are laminated is improved. In other words, the extent to which the upper and lower layers mix with each other is reduced. In addition, that the detected peak is observed at the depth where the interfacial region exists means that any other dissimilar component that is not a main component of each of the upper and lower layers exists in the interfacial region. Here, the main component is a component incorporated at 30 mass % or more into components that form each of the upper and lower layers, and typically refers to a component incorporated at 40 mass % or more, 50 mass % or more when the content is larger, 70 mass % or more when the content is still larger into the components that form each of the upper and lower layers. In addition, the dissimilar component is a component incorporated at less than 30 mass % into the components that form each of the upper and lower layers, and typically refers to a component incorporated at 15 mass % or less, 10 mass % or less when the content is smaller, 5 mass % or less when the content is still smaller into the components that form each of the upper and lower layers; the component typically refers to a component incorporated at substantially 0 mass %.

Detected signals derived from the components that construct the respective upper and lower layers adjacent to each other described in the foregoing are typically broad, and their detected intensities reduce at the depth where the interfacial region exists. It is because the component from which the detected peak is derived exists in the interfacial region that the detected intensities reduce at the depth where the interfacial region exists as described in the foregoing. In addition, when the detected signals derived from the components that construct the respective upper and lower layers adjacent to each other are detected signals of different elements, the detected intensity of a detected signal derived from a component that constructs the upper layer is preferably smaller than the detected intensity of a detected signal derived from a component that constructs the lower layer in the lower layer in ordinary cases, and is more preferably 30% or less, more preferably 20% or less, still more preferably 10% or less, particularly preferably 5% or less with respect to the detected intensity of the detected signal derived from the component that constructs the lower layer. It should be noted that the same holds true for the case where the upper layer and the lower layer are inverted.

Further, the detected intensity of the detected signal of the component from which the detected peak is derived is preferably smaller than the detected intensities of the detected signals derived from the components that construct the respective upper and lower layers in a region except the interfacial region, in other words, the upper and lower layers from such a viewpoint that the functions of the upper and lower layers are not inhibited, and is more preferably 50% or less, more preferably 30% or less, more preferably 20% or less, still more preferably 10% or less, particularly preferably 5% or less with respect to each of the detected intensities of the detected signals derived from the components that construct the respective upper and lower layers.

Here, in the specification, the elemental quantitative analysis in the depth direction by the glow discharge optical emission spectrometry was performed under the following conditions.

### (Conditions for Elemental Quantitative Analysis by Glow Discharge Optical Emission Spectrometry)

Measurement apparatus: “GDS-Profiler2” (manufactured by HORIBA, Ltd.)

RF power source output: 20 W

Argon gas pressure: 800 Pa

Anode diameter: 4 mm

Using pulse power source (frequency:25 Hz, Duty ratio:0.1)

Photometric mode: synchronization (pulse synchronization)

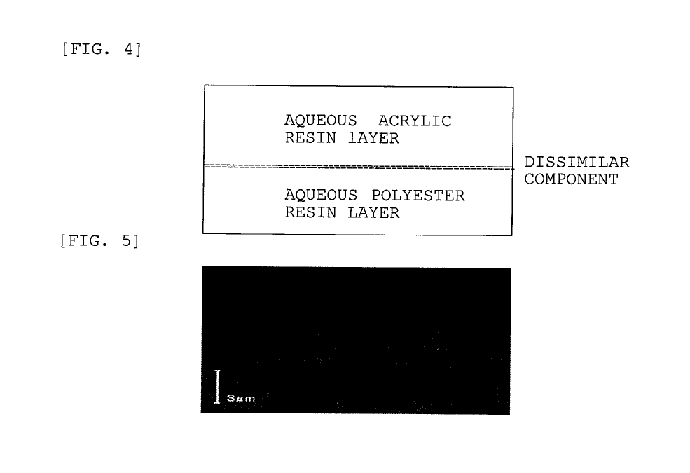

The laminate of the present invention, for example, a laminate obtained in Example 1 is of such a layer construction as illustrated in the schematic view of FIG. 4 in which the dissimilar component exists in the interfacial region between the upper and lower layers. The presence of the dissimilar component can be confirmed by examining an arbitrary element through the elemental quantitative analysis in the depth direction by the glow discharge optical emission spectrometry described in the foregoing. Specifically, when a production method to be described later is adopted, the analysis has only to be performed by paying attention to an element specific to a product produced in the interfacial region by a chemical reaction.

The components of the respective layers that construct the laminate of the present invention are, for example, components for forming layers to be described later. Although the dissimilar component existing in the interfacial region between the two layers is not particularly limited as long as the component is a substance that does not dissolve in the upper and lower layers between which the interfacial region is interposed, the component is preferably, for example, a dissimilar component produced by a chemical reaction to be described later. Specifically, the dissimilar component is preferably a crosslinking reaction product between a polymer material and a crosslinking agent, an agglomeration reaction product between a polymer material and an electrolyte, a complex-forming reaction product between a ligand and an ionic substance, or a neutralization reaction product between an acid and a base. Details about those products are as described in the description of a method of producing a laminate to be described later.

A method of producing such laminate of the present invention is preferably, for example, the following method.

### [Method of Producing Laminate]

The method of producing a laminate of the present invention is a method of producing a laminate including the steps of:

(1) laminating a plurality of solutions prepared by dissolving components for forming layers in solvents;

(2) transferring the solutions laminated in the step (1) onto a substrate; and

(3) drying the laminated solutions transferred onto the substrate,

in which: solvents which two solutions adjacent to each other in the step (1) contain include the same solvent or solvents having compatibility with each other; a component that causes a chemical reaction upon contact of the two solutions is incorporated into at least one of the two solutions so that the chemical reaction of the component is caused upon lamination of the two solutions in the step (1); and a product produced by the chemical reaction is caused to exist in an insolubilized state in an interfacial region between two layers formed of the two solutions adjacent to each other. It should be noted that the product produced by the chemical reaction corresponds to the dissimilar component.

The manner in which the product by the chemical reaction exists in an insolubilized state in the interfacial region between the two layers is not particularly limited as long as the mixing of the two solutions adjacent to each other is suppressed and the laminated structure is maintained. For example, the product may be of a continuous film shape, may be interspersed in an island fashion, or may be in an intermediate state between these states. Here, the term “interfacial region between the two layers” comprehends the very surface (contact surface) where the two solutions adjacent to each other contact each other, and comprehends a region where the two solutions mix with each other near the contact surface as well because the two solutions may slightly mix with each other after the contact of the two solutions.

As described later, each function of the entire laminate is not affected to a large extent because the content of the component that causes a chemical reaction to be used in the present invention in the solution can be made small as compared with the total solid content concentration of the solution. In addition, the product obtained by causing the chemical reaction of the component exists in the interfacial region between the two layers as described in the foregoing. Accordingly, from such viewpoint as well, it can be said that each function of the entire laminate is hardly affected to a large extent.

Although the method of producing a laminate of the present invention is described by taking a method of producing a two-layer laminate as an example for convenience in some cases, the present invention is not limited to the two-layer laminate and is applicable to the production of a laminate having three or more layers as well. Of the solutions to be laminated, a solution for an upper layer may be referred to as “upper layer solution A” and a solution for a lower layer may be referred to as “lower layer solution B.”

Hereinafter, the steps (1) to (3) are described one by one. [Step (1)]

The step (1) is the step of laminating the plurality of solutions prepared by dissolving the components for forming layers in the solvents.

An aqueous solvent and an organic solvent are available as the solvents. Accordingly, an aqueous solution prepared by using the aqueous solvent and an organic solvent-based solution prepared by using mainly the organic solvent are available as the solutions. Although each kind of solution may be used in the present invention, the solvents in the two solutions adjacent to each other in the step (2) to be described later must be the same solvent or solvents compatible with each other. Here, the term “solvents compatible with each other” refers to the following solvents. When one solvent is added to the other solvent, the solvents mix with each other to such an extent that the laminated structure cannot be maintained. An effect of the present invention is expressed by combining the solvents in the two solutions adjacent to each other in such manner in the step (2).

It should be noted that the concentrations of the components for forming layers in the solutions are each preferably 10 to 50 mass %, more preferably 20 to 45 mass % in ordinary cases from the viewpoint of a balance between, for example, the ease with which the laminate is formed and its productivity.

### (Aqueous Solvent)

The aqueous solvent is mainly formed of water, and ion-exchanged water, distilled water, or the like can be used as the water. The aqueous solvent may contain a water-soluble organic solvent such as acetone, methanol, or methyl ethyl ketone as well as water.

The content of water in the aqueous solvent is preferably 80 mass % or more, more preferably 90 mass % or more, more preferably 95 mass % or more, still more preferably substantially 100 mass % from the viewpoint of environmental protection when the present invention is carried out on an industrial scale and the viewpoint of the solubility of a component for forming a layer.

### (Organic Solvent)

Examples of the organic solvent include: aliphatic organic solvents such as hexane, heptane, and cyclohexane; aromatic organic solvents such as toluene, xylene, and bromobenzene; halogenated hydrocarbons such as methylene chloride and ethylene chloride; alcohol-based organic solvents such as methanol, ethanol, propanol, butanol, and 1-methoxy-2-propanol; ketone-based organic solvents such as acetone, methyl ethyl ketone, 2-pentanone, methyl isobutyl ketone, cyclohexanone, and isophorone; ester-based organic solvents such as ethyl acetate and butyl acetate; and cellosolve-based organic solvents such as ethyl cellosolve. One kind of those may be used alone, or two or more kinds thereof may be used in combination.

In the case of a water-soluble organic solvent, water may be incorporated in a small amount. In that case, the content of the organic solvent in the solution is preferably 80 mass % or more, more preferably 90 mass % or more, more preferably 95 mass % or more, still more preferably substantially 100 mass % from the viewpoint of the solubility of a component for forming a layer.

### (Component for Forming Layer for Aqueous Solvent)

A component for forming a layer for the aqueous solvent is not particularly limited as long as the component dissolves in the aqueous solvent and can form the so-called coating film. Examples thereof include hydroxymethylcellulose, hydroxyethylcellulose, methylcellulose, ethylcellulose, carboxymethylcellulose, carboxyethylcellulose, hydroxypropylcellulose, polyvinyl alcohol (PVA) having a degree of saponification of 50 mol % or more (preferably 70 mol % or more) and a derivative thereof, polystyrene sulfonic acid having a degree of sulfonation of 50 mol % or more (preferably 70 mol % or more), an ethylene-vinyl alcohol copolymer having a degree of saponification of 50 mol % or more (preferably 70 mol % or more), polyacrylic acid and a salt thereof, an aqueous acrylic resin, polyvinyl pyrrolidone, polyethylene glycol, alginates, an aqueous polyester resin, an aqueous polyurethane resin, an aqueous epoxy resin, an aqueous polyolefin resin, an aqueous phenolic resin, and polyparavinylphenol. One kind of those may be used alone, or two or more kinds thereof may be used in combination. Of those, an aqueous acrylic resin, an aqueous polyester resin, and polyparavinylphenol are preferred from the viewpoints of film forming property and film thickness uniformity.

It should be noted that the term “aqueous” means that the resin is water-soluble and, though a production method for the aqueous resin is not particularly limited, a commercially available product is conveniently used for any such resin.

An example of the aqueous acrylic resin is a copolymer of acrylic acid and a (meth) acrylic acid alkyl ester or any other polymerizable monomer. Examples of the (meth) acrylic acid alkyl ester include methyl (meth) acrylate, ethyl (meth) acrylate, propyl (meth) acrylate, n-butyl (meth) acrylate, isopropyl (meth) acrylate, isobutyl (meth)acrylate, 2-ethylhexyl (meth)acrylate, n-hexyl (meth) acrylate, and lauryl (meth) acrylate. Examples of the any other polymerizable monomer include 2-hydroxyethyl (meth)acrylate, 2-hydroxypropyl (meth)acrylate, acrylamide, N-methylolacrylamide, diacetoneacrylamide, glycidyl (meth)acrylate, styrene, vinyltoluene, vinyl acetate, acrylonitrile, vinyl alcohol, and ethylene. Further, commercially available products such as a “WATERSOL (registered trademark)” series manufactured by DIC Corporation can also be used.

The aqueous polyester resin can be obtained by subjecting a polyhydric alcohol such as ethylene glycol, propylene glycol, diethylene glycol, 1,6-hexanediol, neopentyl glycol, triethylene glycol, bisphenol hydroxypropyl ether, glycerin, trimethylolethane, or trimethylolpropane and a polybasic acid such as phthalic anhydride, isophthalic acid, terephthalic acid, succinic anhydride, adipic acid, sebacic acid, maleic anhydride, itaconic acid, or fumaric acid to dehydration condensation, neutralizing the resultant with ammonia, an organic amine, or the like, and dispersing the neutralized product in water. Commercially available products such as a “Vylonal (registered trademark)” series manufactured by Toyobo Co., Ltd. can also be used.

It should be noted that the hydroxyl value of the aqueous polyester resin is preferably 5 to 30 KOHmg/g, more preferably 10 to 25 KOHmg/g, still more preferably 10 to 20 KOHmg/g. In addition, the acid value of the aqueous polyester resin is preferably 3 KOHmg/g or less. The glass transition temperature of the aqueous polyester resin is preferably 50 to 90° C., more preferably 60 to 85° C., still more preferably 70 to 85° C.

The polyparavinylphenol is a homopolymer of paravinylphenol, and a commercially available product can be used as the polyparavinylphenol. An example of the commercially available polyparavinylphenol is a “Maruka Lyncur (registered trademark)” series manufactured by Maruzen Petrochemical.

In addition, specific examples of the derivative of polyvinyl alcohol include carboxylated polyvinyl alcohol, sulfonated polyvinyl alcohol, acetoacetylated polyvinyl alcohol, and mixtures thereof.

It should be noted that the weight-average molecular weight of a component for forming a layer is preferably 5,000 to 1,000,000, more preferably 10,000 to 100,000, still more preferably 10,000 to 50,000. It should be noted that each weight-average molecular weight in the specification is a value in terms of polystyrene measured by gel permeation chromatography (GPC).

### (Component for Forming Layer for Organic Solvent-Based Solution)

A component for forming a layer for the organic solvent-based solution is not particularly limited as long as the component dissolves in the organic solvent and can form the so-called coating film, and a thermoplastic resin or an active energy ray-curable compound can be used.

Examples of the thermoplastic resin include a polyester-based resin, a polyester urethane-based resin, an acrylic resin, a modified acrylic resin, polycarbonate, polyvinyl alcohol (PVA) having a degree of saponification of less than 50 mol % (preferably 20 mol % or less) and a derivative thereof, polystyrene sulfonic acid having a degree of sulfonation of less than 50 mol % (preferably 20 mol % or less), and an ethylene-vinyl alcohol copolymer having a degree of saponification of less than 50 mol % (preferably 20 mol % or less). One kind of those may be used alone, or two or more kinds thereof may be used in combination. Those thermoplastic resins have a weight-average molecular weight of preferably several tens of thousand to several millions, more preferably 30,000 to 500,000 from the viewpoints of the ease with which the coating film is formed and its solubility in the organic solvent-based solution.

Further, the active energy ray-curable compound is a compound having an energy quantum in an electromagnetic wave or charged particle beam, that is, a compound the molecules of which crosslink and cure by being irradiated with active energy rays such as ultraviolet rays or electron beams. At least one of such active energy ray-curable oligomers and active energy ray-curable monomers as described below can be used as the active energy ray-curable compound.

Examples of the active energy ray-curable oligomers include polyester acrylate-, epoxy acrylate-, urethane acrylate-, polyether acrylate-, polybutadiene acrylate-, and silicone acrylate-based oligomers.

The weight-average molecular weight of each of the above-mentioned active energy ray-curable oligomers falls within the range of preferably 500 to 100,000, more preferably 1,000 to 70,000, still more preferably 3,000 to 40,000 from the viewpoints of the ease with which the coating film is formed and its solubility in the organic solvent-based solution.

One kind of the active energy ray-curable oligomers may be used alone, or two or more kinds thereof may be used in combination.

Examples of the active energy ray-curable monomers include 1,4-butanedioldi(meth)acrylate, 1,6-hexanedioldi(meth)acrylate, neopentyl glycol di(meth)acrylate, polyethylene glycol di(meth)acrylate, neopentyl glycol adipate di(meth)acrylate, hydroxypivalate neopentyl glycol di(meth)acrylate, dicyclopentanyl di(meth)acrylate, caprolactone-modified dicyclopentenyl di(meth)acrylate, ethyleneoxide-modified phosphate di(meth)acrylate, allylated cylclohexyl di(meth)acrylate, isocyanurate di(meth)acrylate, dimethyloltricyclodecane di(meth)acrylate, trimethylolpropane tri(meth)acrylate, pentaerythritol tri(meth)acrylate, dipentaerythritol tri(meth)acrylate, propionate-modified dipentaerythritol tri(meth)acrylate, pentaerythritol tri(meth)acrylate, propionoxide-modified trimethylolpropane tri(meth)acrylate, tris(acryloxyethyl) isocyanurate, propionate-modified dipentaerythritol penta(meth)acrylate, dipentaerythritol hexa(meth)acrylate, and caprolactone-modified dipentaerythritol hexa(meth)acrylate. One kind of those monomers may be used alone, or two or more kinds thereof may be used in combination.

Further, in addition to the active energy ray-curable compounds, a photopolymerization initiator may also be used. A known photopolymerization initiator can be used, and examples thereof include benzoine, benzoine methyl ether, benzoine ethyl ether, benzoine isopropyl ether, benzoine-n-butylether, benzoineisobutyl ether, acetophenone, dimethylaminoacetophenone, 2,2-dimethoxy-2-phenylacetophenone, 2,2-dimethoxy-1,2-diphenylethane-1-one, 2,2-diethoxy-2-phenylacetophenone, 2-hydroxy-2-methyl-1-phenylpropane-1-one, 1-hydroxycyclohexyl phenyl ketone, 2-benzyl-2-dimethylamino-1-(4-(morpholinophenyl)-butanone-1,2-methyl-1-[4-(methylthio)phenyl]-2-morphorino-propane-1-one, 4-(2-hydroxyethoxy)phenyl-2(hydroxy-2-propyl) ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylamine benzoate, and oligo(2-hydroxy-2-methyl-1-[4-(1-propenyl)phenyl]propanone). One kind of those may be used alone, or two or more kinds thereof may be used in combination.

When the photopolymerization initiator is used, its usage has only to be appropriately selected in accordance with the kind of the active energy ray-curable compound to be used; in general, the photopolymerization initiator is preferably used in an amount ranging from 0.001 to 0.5 times the mass of the active energy ray-curable compound.

In addition, in the present invention, the “component that causes a chemical reaction” to be described later is incorporated into at least one solution of the plurality of solutions to be prepared. By doing so, the chemical reaction of the component can be caused in the step (2) to be described later, and the product produced by the chemical reaction exists in the interfacial region between the two layers formed of the two solutions adjacent to each other. Thus, the laminated structure is maintained. When the component that causes a chemical reaction is not incorporated into any one of the two solutions adjacent to each other, the two solutions adjacent to each other mix with each other in the step (2), and hence the laminated structure cannot be maintained.

### (Other Components)

Various additives such as an antioxidant, a UV absorber, a light stabilizer, a leveling agent, a defoaming agent, a filler, a lubricating agent, and a lubricant can each be further incorporated into the solution prepared by dissolving the component for forming a layer in the solvent as required.

It should be noted that basically, the solid content concentration and viscosity of the solution thus obtained have only to be such a concentration and a viscosity that the solution can be applied, and the concentration and the viscosity can be appropriately selected depending on circumstances.

In the step (1), the plurality of solutions obtained as described above are laminated.

A method of laminating the plurality of solutions, which is not particularly limited, is, for example, (I) a method involving laminating the solutions on an inclined slide surface, (II) a method involving laminating the solutions on a horizontal plane, (III) a method involving laminating the solutions on a circular cylinder, or (IV) a method involving laminating the solutions on an inclined paraboloid. Of those, the method (I) is preferably employed in ordinary cases from the viewpoint of the ease of availability of an apparatus and the viewpoint of the simplicity of operations.

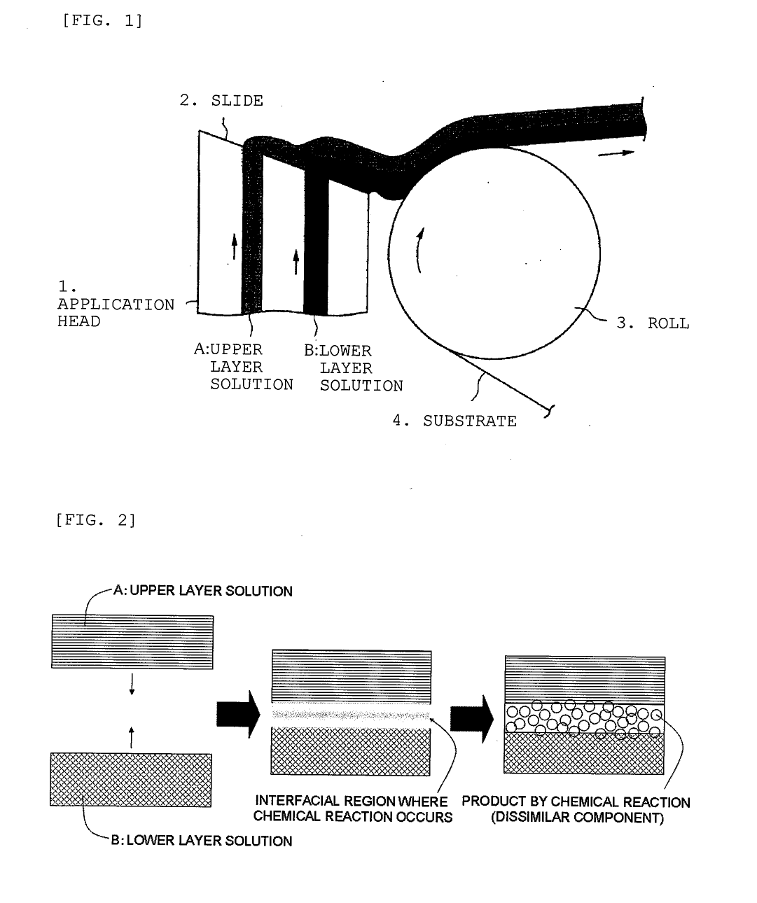

When the method (I) is employed, a product having an inclined slide surface for causing the solutions in which the components for forming layers are dissolved to flow is preferably, for example, such a slide coater as illustrated in FIG. 1.

The inclination angle of the slide surface is preferably 5 to 40°, more preferably 10 to 35°, still more preferably 15 to 35° with respect to a horizontal direction from the viewpoint of efficient formation of the laminate. In addition, a distance between the center of an orifice for ejecting a solution onto the slide surface and the center of an adjacent orifice for ejecting a solution is preferably 8 to 30 cm, more preferably 10 to 28 cm, still more preferably 12 to 26 cm from the viewpoint of the efficient formation of the laminate. Further, a distance between the center of the ejection orifice closest to a site where the laminated solutions are transferred onto a substrate out of the plurality of orifices for ejecting solutions onto the slide surface and the substrate is preferably 2 to 14 cm, more preferably 3 to 12 cm, still more preferably 4 to 11 cm from the viewpoint of the efficient formation of the laminate. The effect of the present invention tends to appear saliently particularly when a slide coater designed as described in the foregoing is used.

When attention is paid to the two solutions adjacent to each other, in other words, the upper layer solution A and the lower layer solution B, the method of laminating the plurality of solutions in the step (1) is preferably, for example, a method involving laminating the upper layer solution A and the lower layer solution B while causing a chemical reaction through the contact of the solution B with the solution A.

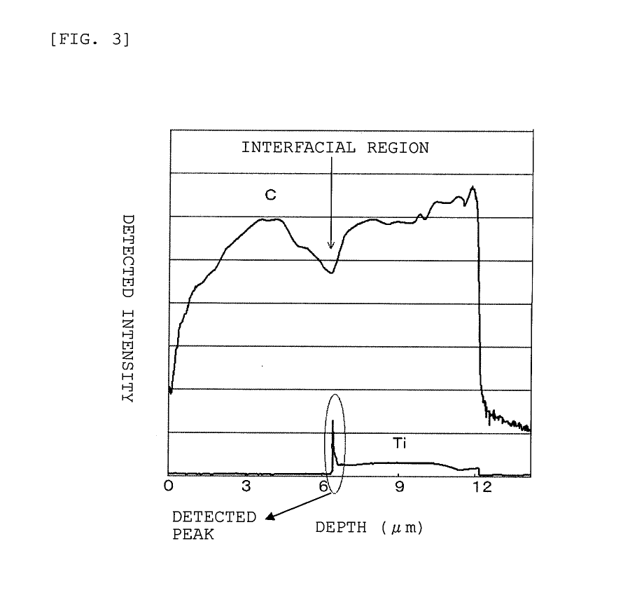

The chemical reaction is not particularly limited as long as a product hardly soluble or insoluble in the solvents is produced by the chemical reaction in the interfacial region between the two layers as illustrated in FIG. 2 so that the laminated structure of the solutions adjacent to each other can be maintained, and assorted chemical reactions can each be utilized. Preferred specific examples of the reaction include the following chemical reactions (A) to (D). It should be noted that FIG. 2 is an image view and the laminated structure is not necessarily formed as illustrated in FIG. 2 by the chemical reaction in the present invention.

(A) A crosslinking reaction

(B) An agglomeration reaction based on salting out

(C) A complex-forming reaction

(D) A neutralization reaction between an acid and a base Hereinafter, examples of the chemical reactions (A) to (D) are described one by one.

### —(A) Crosslinking Reaction—

For example, when a crosslinkable polymer material is used as a component (a) to be incorporated into one solution and a crosslinking agent is used as a component (b) to be incorporated into the other solution, a crosslinking reaction occurs in the interfacial region formed of the two solutions. A crosslinked body as a product of the crosslinking reaction is hardly soluble or insoluble in the solvents, and can exist in an insolubilized state in the interfacial region between the two layers to suppress the mixing of the upper layer solution A and the lower layer solution B. Accordingly, it is assumed that the laminated structure can be maintained.

Although the crosslinkable polymer material as the component (a) is not particularly limited, examples of the material include polymer materials each having a hydroxyl group, a carboxyl group, or the like such as a polyvinyl alcohol, a polyphenol, and a polycarboxylic acid. One kind of those materials may be used alone, or two or more kinds thereof may be used in combination. The crosslinkable polymer material has a weight-average molecular weight of preferably 5,000 to 300,000, more preferably 30,000 to 200,000, still more preferably 50,000 to 150,000 from the viewpoint of its solubility in a solvent.

In addition, examples of the crosslinking agent as the component (b) include: crosslinkable titanium compounds such as titanium hydroxide and an organotitanium chelate compound; crosslinkable zirconium compounds; amino resins such as a urea resin and a melamine resin; polyisocyanate compounds such as hexamethylene diisocyanate, tolylene diisocyanate, xylylene diisocyanate, and isophorone diisocyanate; epoxy compounds such as adipic acid diglycidyl ester, phthalic acid diglycidyl ester, terephthalic acid diglycidyl ester, pentaerythritol polyglycidyl ether, glycerin polyglycidyl ether, trimethylpropane polyglycidyl ether, neopentyl glycol polyglycidyl ether, ethylene glycol diglycidyl ether, polyethylene glycol diglycidyl ether, propylene glycol diglycidyl ether, polypropylene glycol diglycidyl ether, 2,2-bis-(4′-glycidyloxyphenyl)propane, tris(2,3-epoxypropyl) isocyanurate, bisphenol A diglycidyl ether, and hydrogenated bisphenol A diglycidyl ether; carbodiimide compounds; and silane coupling agents such as vinyltrimethoxysilane, vinyltriethoxysilane, γ-aminopropyltrimethoxysilane, γ-aminopropylethoxysilane, N-[2-(vinylbenzylamino) ethyl]-3-aminopropyltrimethoxysilane, γ-methacryloxypropylmethyldimethoxysilane, and γ-methacryloxypropyltrimethoxysilane. One kind of those may be used alone, or two or more kinds thereof may be used in combination.

It should be noted that when the crosslinking reaction is utilized, a non-crosslinkable component (non-crosslinkable component for forming a layer) that does not react with the crosslinking agent must be used as a component for forming a layer in the solution containing the crosslinking agent, and an aqueous acrylic resin, an aqueous polyester resin, or the like is preferred as such component.

When the crosslinking reaction is utilized, the contents of the components in the solutions are as described below from the viewpoint of the maintenance of the laminated structure of the upper layer solution A and the lower layer solution B, and the viewpoint of the reductions of influences on the functions of the respective layers. The content of the crosslinkable polymer material in one layer-forming solution is preferably 5 to 30 mass %, more preferably 5 to 20 mass %, still more preferably 8 to 15 mass %, and the content of the crosslinking agent in the other layer-forming solution is preferably 1 to 20 mass %, more preferably 1 to 10 mass %, still more preferably 3 to 8 mass %.

### —(B) Agglomeration Reaction Based on Salting Out—

For example, when a polymer material is used as the component (a) and an electrolyte is used as the component (b), salting out in which the electrolyte deprives the polymer material having agglomerating property of the solvent around the material occurs, and by extension, the agglomeration reaction of the polymer material progresses in the interfacial region formed of the two solutions. An agglomerate as a product of the agglomeration reaction is hardly soluble or insoluble in the solvents, and can exist in an insolubilized state in the interfacial region between the two layers to suppress the mixing of the upper layer solution A and the lower layer solution B. Accordingly, it is assumed that the laminated structure can be maintained.

Examples of the polymer material as the above-mentioned component (a) include hydrophilic polymer materials each having a hydroxyl group, a carboxyl group, or the like such as a polyvinyl alcohol, a polyphenol, and a polycarboxylic acid. One kind of those materials may be used alone, or two or more kinds thereof may be used in combination.

A known material can be used as the electrolyte as the above-mentioned component (b), and examples of the electrolyte include: binary electrolytes such as sodium chloride and calcium chloride; ternary electrolytes such as barium chloride; amphoteric electrolytes each having acidity and alkalinity such as aluminum hydroxide; and polymer electrolytes such as a protein and a polymethacrylic acid.

It should be noted that when the agglomeration reaction is utilized, a polymer material that does not cause salting out must be used as a component for forming a layer in the solution containing the electrolyte, and an aqueous acrylic resin, an aqueous polyester resin, or the like is preferred as such material.

When the agglomeration reaction based on salting out is utilized, the contents of the components in the solutions are as described below from the viewpoint of the maintenance of the laminated structure of the upper layer solution A and the lower layer solution B, and the viewpoint of the reductions of influences on the functions of the respective layers. The content of the polymer material in one layer-forming solution is preferably 5 to 30 mass %, more preferably 5 to 20 mass %, still more preferably 8 to 15 mass %, and the content of the electrolyte in the other layer-forming solution is preferably 0.5 to 10 mass %, more preferably 1 to 7 mass %, still more preferably 1 to 5 mass %.

### —(C) Complex-Forming Reaction—

For example, when a ligand is used as the component (a) and an ionic substance is used as the component (b), a complex-forming reaction occurs in the interfacial region formed of the two solutions. A complex as a product of the complex-forming reaction is hardly soluble or insoluble in the solvents, and can exist in an insolubilized state in the interfacial region between the two layers to suppress the mixing of the upper layer solution A and the lower layer solution B. Accordingly, it is assumed that the laminated structure can be maintained.

Examples of the ligand as the above-mentioned component (a) include: phosphorus-containing ligands such as phosphorous acid, phosphoric acid, and a polyphosphoric acid; carboxylic acid-containing ligands such as acetic acid; and ligands each containing a hydroxyl group, a thiol group, or the like.

In addition, the ionic substance as the component (b) is not particularly limited as long as the substance serves as an ion source of, for example, a calcium ion or a magnesium ion, and examples of the substance include calcium hydroxide and magnesium hydroxide.

When the complex-forming reaction is utilized, the contents of the components in the solutions are as described below from the viewpoint of the maintenance of the laminated structure of the upper layer solution A and the lower layer solution B, and the viewpoint of the reductions of influences on the functions of the respective layers. The content of the ligand in one solution is preferably 5 to 30 mass %, more preferably 5 to 20 mass %, still more preferably 5 to 15 mass %, and the content of the ionic substance in the other solution is preferably 0.1 to 10 mass %, more preferably 0.5 to 7 mass %, still more preferably 1 to 5 mass %.

### —(D) Neutralization Reaction Between Acid and Base—

For example, when an acid is used as the component (a) and a base is used as the component (b), a neutralization reaction between the acid and the base occurs in the interfacial region formed of the two solutions. A salt as a product of the neutralization reaction is hardly soluble or insoluble in the solvents, and can exist in an insolubilized state in the interfacial region between the two layers to suppress the mixing of the upper layer solution A and the lower layer solution B. Accordingly, it is assumed that the laminated structure can be maintained.

Examples of the above-mentioned acid as the component (a) include weak acids such as acetic acid, formic acid, and carbonic acid.

Examples of the above-mentioned base as the component (b) include weak bases typified by organic amines and nitrogen-containing heterocyclic aromatic compounds such as monoethanolamine, diethanolamine, triethanolamine, pyridine, benzidine, aniline, and quinoline.

When the neutralization reaction between the acid and the base is utilized, the contents of the components in the solutions are as described below from the viewpoint of the maintenance of the laminated structure of the upper layer solution A and the lower layer solution B, and the viewpoint of the reductions of influences on the functions of the respective layers. The contents of the acid and the base in the solutions are each preferably 1 to 30 mass %, more preferably 1 to 20 mass %, still more preferably 5 to 15 mass %.

Examples of the method of laminating the plurality of solutions include the following methods as well as the above-mentioned methods:

(i) a method involving using a catalyst and a compound that contacts the catalyst to cause a chemical reaction such as polymerization [chemical reaction: a polymerization reaction or the like];
(ii) a method involving incorporating a compound that causes a chemical reaction (such as a crosslinking reaction or a polymerization reaction) as a result of a temperature change into one solution, changing the temperatures of the solutions, and bringing the two solutions into contact with each other [chemical reaction: the crosslinking reaction (A), a polymerization reaction, or the like];
(iii) a method involving incorporating a compound that contacts a specific solvent to cause a chemical reaction into one solution and bringing the solution into contact with the other solution; and
(iv) a method involving incorporating a compound that contacts a specific component for forming a layer to cause a chemical reaction into one solution and bringing the solution into contact with the other solution.

The effect of the present invention can be relished as long as a product produced by any such chemical reaction is hardly soluble or insoluble in the solvents and exists in the interfacial region between the two layers adjacent to each other.

### [Step (2)]

The step (2) is the step of transferring the layer-forming solutions laminated as described above onto the substrate.

### (Substrate)

A substrate is not particularly limited, and can be appropriately selected in accordance with the applications of a member having the laminate. Examples of the substrate include polyester-based films such as a polyethylene terephthalate film, a polybutylene terephthalate film, and a polyethylene naphthalate film; polyolefin-based films such as a polyethylene film and a polypropylene film; cellulose-based films such as cellophane, a diacetylcellulose film, a triacetylcellulose film, and an acetylcellulose butyrate film; vinyl chloride-based films such as a polyvinyl chloride film and a polyvinylidene chloride film; polyvinyl alcohol films; vinyl-based copolymer films such as a ethylene/vinyl acetate copolymer film; polystyrene films; polycarbonate films; polymethylpentene films; polysulfone films; polyether-based films such as a polyetheretherketone film, a polyethersulfone film, and a polyetherimide film; polyimide films; fluororesin films; polyamide films; acrylic resin films; norbornene-based resin films; and cycloolefin resin films.

The substrates may be transparent, or may be semitransparent, and may be colored, or may be colorless; an appropriate substrate has only to be selected in accordance with the applications.

The thickness of the substrate is not particularly limited, and is appropriately selected in accordance with circumstances; the thickness falls within the range of typically 15 to 250 μm, preferably 30 to 200 μm.

In addition, one surface or both surfaces of the substrate can be subjected to a surface treatment by, for example, an oxidation method or irregularity method as desired with a view to improving adhesiveness between a surface and a layer provided on the surface. Examples of the above-mentioned oxidation method include a corona discharge treatment, a chromic acid treatment (wet), a flame treatment, a hot air treatment, and an ozone/UV irradiation treatment. In addition, examples of the irregularity method include a sandblast method and a solvent treatment method. A method for the surface treatment is appropriately selected from those methods in accordance with the kind of the substrate; in general, the corona discharge treatment method is preferably employed from the viewpoints of, for example, its effect and operability.

Hereinafter, an example of a method involving laminating a plurality of solutions and transferring the solutions onto a substrate is described in detail with reference to the slide coater of FIG. 1.

The upper layer solution A and the lower layer solution B are ejected from the respective ejection orifices in an application head 1 having a plurality of slit-like ejection orifices, and are then caused to naturally flow down on an inclined slide surface 2 by gravitation so that the upper layer solution A and the lower layer solution B may be laminated. The laminated solutions are transferred onto a running substrate 4 by a roll 3. Then, the production method moves to the next step (3).

### [Step (3)]

The step (3) is the step of drying the plurality of solutions in a laminated state transferred in the step (2) under heating to form the laminate. The temperature at which the solutions are dried under heating is typically preferably 50 to 130° C., more preferably 60 to 120° C. The time period necessary for drying the solutions under heating, which is not particularly limited, is typically about 1 to 5 minutes.

The thickness of each layer of the laminate thus obtained is preferably about 0.1 to 100 μm, more preferably 1 to 70 μm in ordinary cases so that the laminated structure of the respective layers may be maintained. The laminated structure can be observed with, for example, an interfacial ultraviolet and visible spectrophotometer utilizing slab optical waveguide spectrometry. The structure can be observed by investigating its section with a scanning electron microscope (SEM) or an optical microscope as well.

The production method of the present invention may be performed continuously or intermittently by using large amounts of the solutions, or may be performed on the basis of a batch mode by using minimum required amounts of the solutions.

The laminate obtained as described above is such a laminate that a product produced by a chemical reaction exists in an interfacial region between at least one pair of layers adjacent to each other in the laminate. More specifically, one laminate of the present invention is the following laminate. The laminate has a layer containing a component for forming a layer and the component (a), and a layer containing a component for forming a layer and the component (b) that causes a chemical reaction with the component (a) above or below the foregoing layer, and a product produced by the occurrence of the chemical reaction between the components (a) and (b) exists in an interfacial region between both the layers. Another laminate of the present invention is the following laminate. The laminate has a layer containing a component for forming a layer and a component that causes a chemical reaction, and a layer containing a component for forming a layer above or below the foregoing layer, and a product produced by the occurrence of the chemical reaction of the component that causes a chemical reaction exists in an interfacial region between both the layers.

Examples of any such chemical reaction as described above include, but not limited to, the chemical reactions (A) to (D).

In addition, the production method of the present invention may be performed continuously or intermittently by using large amounts of the solutions, or may be performed on the basis of a batch mode by using minimum required amounts of the solutions.

As the component produced by any such chemical reaction exists in the interfacial region between the layers, a detected peak having a full width at half maximum of 0.01 to 0.7 μm derived from the component produced by the chemical reaction is observed in, for example, elemental quantitative analysis in a depth direction by a glow discharge optical emission spectrometry.

### EXAMPLES

Next, the present invention is described in more detail by way of examples. However, the present invention is by no means limited by those examples.

### (A) Preparation of Solution for Crosslinking Reaction

### Production Example A-1

### Aqueous Solution for Upper Layer

20 Grams of a polyvinyl alcohol (manufactured by KANTO CHEMICAL CO., INC., weight-average molecular weight: about 100,000), 155 g of an aqueous acrylic resin (component for forming a layer, “WATERSOL (registered trademark) PW-1100” manufactured by DIC Corporation, weight-average molecular weight: about 50,000, water emulsion having a solid content concentration of 45 mass %), and 0.5 g of indigo (manufactured by KANTO CHEMICAL CO., INC.) as a colorant for identification were mixed and stirred at room temperature. Thus, a blue aqueous solution A-1 (concentration of the polyvinyl alcohol: about 12 mass %) was obtained.

### Production Example A-2

### Aqueous Solution for Lower Layer

Grams of a crosslinkable titanium compound (“ORGATIX (registered trademark) TC-400” manufactured by Matsumoto Trading Co., Ltd., component; titanium diisopropoxybis(triethanolaminate)), 130 g of an aqueous polyester resin (Vylonal MD-1500 manufactured by Toyobo Co., Ltd., glass transition temperature: 77° C., weight-average molecular weight: about 20,000, solid content concentration: 30 mass %), and 0.5 g of anthraquinone (manufactured by KANTO CHEMICAL CO., INC.) as a colorant for identification were mixed and stirred at room temperature. Thus, a red aqueous solution A-2 (concentration of the crosslinkable titanium compound: about 5 mass %) was obtained.

### (B) Preparation of Solution for Agglomeration Reaction Based on Salting Out

### Production Example B-1

### Aqueous Solution for Upper Layer

20 Grams of a polyvinyl alcohol (manufactured by KANTO CHEMICAL CO., INC., weight-average molecular weight: about 100,000), 155 g of an aqueous acrylic resin (component for forming a layer, “WATERSOL (registered trademark) PW-1100” manufactured by DIC Corporation, weight-average molecular weight: about 50,000, water emulsion having a solid content concentration of 45 mass %), and 0.5 g of indigo (manufactured by KANTO CHEMICAL CO., INC.) as a colorant for identification were mixed and stirred at room temperature. Thus, a blue aqueous solution B-1 (concentration of the polyvinyl alcohol: about 12 mass %) was obtained.

### Production Example B-2

### Aqueous Solution for Lower Layer

3 Grams of sodium chloride (manufactured by KANTO CHEMICAL CO., INC., electrolyte), 130 g of an aqueous polyester resin (“Vylonal MD-1500” manufactured by Toyobo Co., Ltd., glass transition temperature: 77° C., weight-average molecular weight: about 20,000, solid content concentration: 30 mass %), and 0.5 g of anthraquinone (manufactured by KANTO CHEMICAL CO., INC.) as a colorant for identification were mixed and stirred at room temperature. Thus, a red aqueous solution B-2 (concentration of sodium chloride: about 3 mass %) was obtained.

### (C) Preparation of Solution for Complex-Forming Reaction

### Production Example C-1

### Aqueous Solution for Upper Layer

15 Grams of phosphoric acid (manufactured by KANTO CHEMICAL CO., INC., ligand), 70 g of polyparavinylphenol (component for forming a layer, “Maruka Lyncur (registered trademark) M” manufactured by Maruzen Petrochemical, weight-average molecular weight: about 20,000), 80 g of pure water (manufactured by KANTO CHEMICAL CO., INC.), and 0.5 g of indigo (manufactured by KANTO CHEMICAL CO., INC.) as a colorant for identification were mixed and stirred at room temperature. Thus, a blue aqueous solution C-1 (concentration of phosphoric acid: about 9 mass %) was obtained.

### Production Example C-2

### Aqueous Solution for Lower Layer

2 Grams of calcium hydroxide (manufactured by KANTO CHEMICAL CO., INC., ionic substance), 130 g of an aqueous polyester resin (“Vylonal (registered trademark) MD-1500” manufactured by Toyobo Co., Ltd., glass transition temperature: 77° C., weight-average molecular weight: about 20,000, solid content concentration: 30 mass %), and 0.5 g of anthraquinone (manufactured by KANTO CHEMICAL CO., INC.) as a colorant for identification were mixed and stirred at room temperature. Thus, a red aqueous solution C-2 (concentration of the ionic substance: about 2 mass %) was obtained.

### (D) Preparation of Solution for Neutralization Reaction Between Acid and Base

### Production Example D-1

### Aqueous Solution for Upper Layer

15 Grams of triethanolamine (manufactured by KANTO CHEMICAL CO., INC.), 70 g of polyparavinylphenol (component for forming a layer, “Maruka Lyncur (registered trademark) M” manufactured by Maruzen Petrochemical, weight-average molecular weight: about 20,000), 80 g of pure water (manufactured by KANTO CHEMICAL CO., INC.), and 0.5 g of indigo (manufactured by KANTO CHEMICAL CO., INC.) as a colorant for identification were mixed and stirred at room temperature. Thus, a blue aqueous solution D-1 (concentration of triethanolamine: about 9 mass %) was obtained.

### Production Example D-2

### Aqueous Solution for Lower Layer

10 Grams of acetic acid (manufactured by KANTO CHEMICAL CO., INC.), 130 g of an aqueous polyester resin (“Vylonal (registered trademark) MD-1500” manufactured by Toyobo Co., Ltd., glass transition temperature: 77° C., weight-average molecular weight: about 20,000, solid content concentration: 30 mass %), and 0.5 g of anthraquinone (manufactured by KANTO CHEMICAL CO., INC.) as a colorant for identification were mixed and stirred at room temperature. Thus, a red aqueous solution D-2 (concentration of the acidic material: about 9 mass %) was obtained.

The details of each aqueous solution for forming a layer obtained in the above-mentioned production examples are summarized in Table 1.

TABLE 1

| | | Component (a) | Component (b) | Product [element to |
|---|---|---|---|---|
| | | that causes | that causes | which attention should |
| | | chemical reaction | chemical reaction | be paid in glow discharge |
| | | in upper layer | in lower layer | optical emission |
| | | solution 1 | solution 2 | spectrometry] |
| Chemical | (A) | Polyvinyl alcohol | Cross linkable | Polyvinyl alcohol |
| reaction | | (crosslinkable | titanium compound | crosslinked body |
| | | polymer material) | (crosslinking agent) | [titanium element] |
| | (B) | Polyvinyl alcohol | Sodium chloride | Polyvinyl alcohol |
| | | (polymer material) | (electrolyte) | agglomerate |
| | | | | [sodium element] |
| | (C) | Phosphoric acid | Calcium hydroxide | Calcium phosphate |
| | | (ligand) | (ionic substance) | complex |
| | | | | [phosphorus element] |
| | (D) | Triethanolamine | Acetic acid | Neutralized salt |
| | | (weak base) | (weak acid) | [nitrogen element] |

### Example 1

The aqueous solution A-1 produced in Production Example A-1 to be used for an upper layer and the aqueous solution A-2 produced in Production Example A-2 to be used for a lower layer were applied onto a polyethylene terephthalate film “COSMOSHINE A4100” having a thickness of 100 μm (manufactured by Toyobo Co., Ltd.) with the apparatus illustrated in FIG. 1 (inclination angle of the slide surface; 25° with respect to a horizontal direction, distance between adjacent ejection orifices; 8 cm, distance between the center of the ejection orifice closest to a site where the laminated aqueous solutions were transferred onto the substrate and the substrate; 10 cm), and were then dried in an oven at 70° C. for 2 minutes. Thus, a laminate was obtained. The thickness of each layer was about 6 μm.

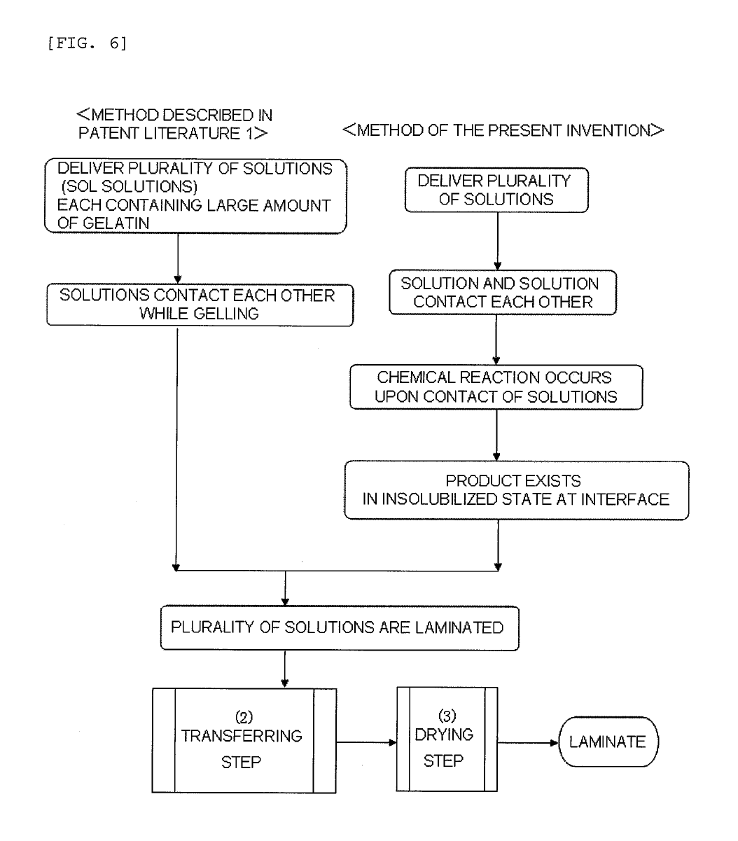

A section of the resultant laminate was subjected to visual judgment on red and blue colors, and to observation with a scanning electron microscope (SEM). As a result, as shown in FIG. 5, no significant mixing of the colorants for identification was observed in the two layers, i.e., the upper layer and the lower layer to which the colorants for identification had been added. Accordingly, the confirmation of the fact that the laminated structure was favorably maintained was attained.

Further, the resultant laminate was subjected to elemental quantitative analysis in its depth direction with respect to a coating surface with a glow discharge optical emission spectrometer (“GD-Profiler2” manufactured by HORIBA, Ltd.) under the following conditions by paying attention to a titanium element as a marking element. FIG. 3 shows the result. As can be seen from FIG. 3, the titanium element existed as a local maximum peak in the interfacial region, and the full width at half maximum of the detected peak was 0.4 μm.

(Conditions for elemental quantitative analysis by glow discharge optical emission spectrometry)

Measurement apparatus: “GDS-Profiler2” (manufactured by HORIBA, Ltd.)

RF power source output: 20 W

Argon gas pressure: 800 Pa

Anode diameter: 4 mm

Using pulse power source (frequency:25 Hz, Duty ratio:0.1)

Photometric mode: synchronization (pulse synchronization) (Analyte elements and measurement wavelengths in glow discharge optical emission spectrometry)

Carbon (C): 156.144 nm

Titanium (Ti): 364.275 nm

### Example 2

A laminate was produced in the same manner as in Example 1 except that: the aqueous solution B-1 produced in Production Example B-1 was used as a solution for an upper layer instead of the aqueous solution A-1 produced in Production Example A-1; and the aqueous solution B-2 produced in Production Example B-2 was used as a solution for a lower layer instead of the aqueous solution A-2 produced in Production Example A-2. The thickness of each layer was about 6 μm.

A section of the resultant laminate was subjected to visual judgment on red and blue colors, and to observation with a scanning electron microscope (SEM). As a result, no significant mixing of the colorants for identification was observed in the two layers, i.e., the upper layer and the lower layer to which the colorants for identification had been added. Accordingly, the confirmation of the fact that the laminated structure was favorably maintained was attained.

In addition, elemental quantitative analysis was performed by a glow discharge optical emission spectrometry in the same manner as in Example 1. As a result, it was found that a sodium element existed as a local maximum peak in the interfacial region, and the full width at half maximum of the detected peak was 0.1 μm.

### Example 3

A laminate was produced in the same manner as in Example 1 except that: the aqueous solution C-1 produced in Production Example C-1 was used as a solution for an upper layer instead of the aqueous solution A-1 produced in Production Example A-1; and the aqueous solution C-2 produced in Production Example C-2 was used as a solution for a lower layer instead of the aqueous solution A-2 produced in Production Example A-2. The thickness of each layer was about 6 μm.

A section of the resultant laminate was subjected to visual judgment on red and blue colors, and to observation with a scanning electron microscope (SEM). As a result, no significant mixing of the colorants for identification was observed in the two layers, i.e., the upper layer and the lower layer to which the colorants for identification had been added. Accordingly, the confirmation of the fact that the laminated structure was favorably maintained was attained.

In addition, elemental quantitative analysis was performed by a glow discharge optical emission spectrometry in the same manner as in Example 1. As a result, it was found that a phosphorus element existed as a local maximum peak in the interfacial region, and the full width at half maximum of the detected peak was 0.3 μm.

### Example 4

A laminate was produced in the same manner as in Example 1 except that: the aqueous solution D-1 produced in Production Example D-1 was used as a solution for an upper layer instead of the aqueous solution A-1 produced in Production Example A-1; and the aqueous solution D-2 produced in Production Example D-2 was used as a solution for a lower layer instead of the aqueous solution A-2 produced in Production Example A-2. The thickness of each layer was about 6 μm.

A section of the resultant laminate was subjected to visual judgment on red and blue colors, and to observation with a scanning electron microscope (SEM). As a result, no significant mixing of the colorants for identification was observed in the two layers, i.e., the upper layer and the lower layer to which the colorants for identification had been added. Accordingly, the confirmation of the fact that the laminated structure was favorably maintained was attained.

In addition, elemental quantitative analysis was performed by a glow discharge optical emission spectrometry in the same manner as in Example 1. As a result, it was found that a nitrogen element existed as a local maximum peak in the interfacial region, and the full width at half maximum of the detected peak was 0.6 μm.

### Comparative Example 1

A laminate was formed on a polyethylene terephthalate film in the same manner as in Example 1 except that an aqueous solution into which no polyvinyl alcohol had been incorporated was used in Production Example A-1. A section of the laminate was observed with an SEM. As a result, the colorants for identification mixed with each other, and hence the laminated structure was not maintained. In addition, elemental quantitative analysis was performed by a glow discharge optical emission spectrometry in the same manner as in Example 1. As a result, the full width at half maximum of a portion assumed to be the signal of an element to which attention should have been paid was about 1 μm.

### Comparative Example 2

A laminate was formed on a polyethylene terephthalate film in the same manner as in Example 1 except that an aqueous solution into which no crosslinkable titanium compound had been incorporated was used in Production Example A-2. A section of the laminate was observed with an SEM. As a result, the colorants for identification mixed with each other, and hence the laminated structure was not maintained. In addition, elemental quantitative analysis was performed by a glow discharge optical emission spectrometry in the same manner as in Example 1. As a result, the full width at half maximum of a portion assumed to be the signal of an element to which attention should have been paid was about 1.5 μm.

### Comparative Examples 3 to 8

When one of the components (a) and (b) causing chemical reactions used in each production example was not incorporated into an aqueous solution in any one of Examples 2 to 4, the aqueous solutions for upper and lower layers mixed with each other in each of the examples, and hence the laminated structure was not maintained. In addition, elemental quantitative analysis was performed by a glow discharge optical emission spectrometry in the same manner as in Example 1. As a result, the full width at half maximum of a portion assumed to be the signal of an element to which attention should have been paid was about 1 to 1.5 μm.

The foregoing results show that the production method of the present invention enables the lamination of solutions of the same kind or of solutions compatible with each other which has been difficult in ordinary cases. In addition, in such laminate of the present invention, significant mixing of the layers is suppressed. Accordingly, a function which each layer should express is expressed comparably, and at the same time, high interlayer adhesiveness can be secured as a result of slight mixing of the layers.

### INDUSTRIAL APPLICABILITY

The laminate of the present invention can find use in a wide variety of fields including various optical films, film antennas for cars, heat-dissipating sheets, and infrared light-reflecting films because various functions such as hard coat property and transparency can be imparted to the laminate.

1. A laminate comprising at least one pair of layers adjacent to each other, wherein the laminate shows a detected peak having a full width at half maximum of 0.01 to 0.7 μm at a depth where an interfacial region between the layers adjacent to each other exists in elemental quantitative analysis in its depth direction by a glow discharge optical emission spectrometry.

2. A laminate comprising at least one pair of layers adjacent to each other, wherein the laminate shows a detected peak having a full width at half maximum of 0.01 to 0.7 μm at a depth where detected signals derived from the components that construct the upper and lower layers adjacent to each other contact each other in elemental quantitative analysis in its depth direction by a glow discharge optical emission spectrometry.

3. A method of producing a laminate, comprising the steps of:
(1) laminating a plurality of solutions prepared by dissolving components for forming layers in solvents;
(2) transferring the solutions laminated in the step (1) onto a substrate; and
(3) drying the laminated solutions transferred onto the substrate,
wherein:
solvents which two solutions adjacent to each other in the step (1) contain comprise the same solvent or solvents having compatibility with each other;
a component that causes a chemical reaction upon contact of the two solutions is incorporated into at least one of the two solutions so that the chemical reaction of the component is caused upon lamination of the two solutions in the step (1); and
a product produced by the chemical reaction is caused to exist in an insolubilized state in an interfacial region between two layers formed of the two solutions adjacent to each other.

4. The method of producing a laminate according to claim 3, wherein the chemical reaction comprises a crosslinking reaction, an agglomeration reaction based on salting out, a complex-forming reaction, a neutralization reaction between an acid and a base, or a polymerization reaction.
